(19) United States
(12) Patent Application Publication
(10) Pub. No.: US 2016/0187367 A1
(43) Pub. Date: Jun. 30, 2016

(54) Method for Determining Remaining Service Time and Apparatus Thereof

(71) Applicant: Xiaomi Inc., Beijing (CN)

(72) Inventors: Ming ZHAO, Beijing (CN); Yue LIANG, Beijing (CN); Enxing HOU, Beijing (CN)

(73) Assignee: Xiaomi Inc.

(21) Appl. No.: 14/947,957

(22) Filed: Nov. 20, 2015

Related U.S. Application Data
(63) Continuation of application No. PCT/CN2015/080805, filed on Jun. 4, 2015.

(30) Foreign Application Priority Data
Dec. 31, 2014 (CN) 201410852715.X

(51) Int. Cl. G01P 5/00

(52) U.S. Cl. CPC G01P 5/00

(57) ABSTRACT

The present disclosure related to a method for determining remaining service time for a filter in an air moving target device and an apparatus thereof, belonging to a field of Internet technology. The method includes acquiring operation information of the air moving target device, which includes power-on/off time of the target device, determining an average running wind speed of the target device according to the operation information, and determining the remaining service time of the target device according to the average running wind speed of the target device, attribute information of the target device and environment data. According to the present disclosure, by acquiring operation information of a target device and determining an average running wind speed of the target device according to the operation information, the remaining service time of the target device is thus determined according to the average running wind speed of the target device, attribute information of the target device and environment data. Since the remaining service time of the target device is determined according to some reliable data such as operation information of the target device, attribute information of the target device and environment data, the real use state of the device may be reflected more accurately.

### CROSS-REFERENCE TO RELATED APPLICATIONS

The present application is a continuation of International Application No. PCT/CN2015/080805, filed on Jun. 4, 2015, which is based upon and claims priority to Chinese Patent Application No. 201410852715.X, filed on Dec. 31, 2014, the entire contents of which are incorporated herein by reference.

### FIELD

The present application relates to a field of Internet technology, and more particularly to a method for determining remaining service time and an apparatus thereof.

### BACKGROUND

The statements in this section merely provide background information related to the present disclosure and may not constitute prior art.

With the increasingly severe air pollution, more and more users use air purifiers to improve air quality in the living spaces. As a filter element is a key component of an air purifier, the lifespan of the filter element has become an important indicator of the quality of the air purifier. With the growth in the operation time, the filter element of the air purifier is gradually wasted. However, many users fail to timely replace the filter because they do not know the remaining service time of the filter element, causing the air purifier to operate inefficiently. In order to enable the users to timely replace the filter element according to the remaining service time of the filter element so as to create a good living environment, there is an urgent need for a method for determining the remaining service time of a filter element of an air purifier filter more accurately.

### SUMMARY

In order to overcome the problem in the prior art, the present disclosure provides a method for determining remaining service time and an apparatus thereof.

According to a first aspect of the present disclosure, there is provided a method for determining remaining service time, including acquiring operation information of a target device, which includes power-on/off time of the target device, determining an average running wind speed of the target device according to the operation information, and determining the remaining service time of the target device according to the average running wind speed of the target device, attribute information of the target device and environment data.

In combination with the first aspect, in a first possible implement of the first aspect, the determining an average running wind speed of the target device according to the operation information includes determining the number of operation days of the target device according to the power-on/off time of the target device, determining whether the number of operation days reaches a preset number of days, acquiring a first average running wind speed according to operation information of a plurality of surrounding devices when the number of operation days does not reach the preset number of days, and acquiring a second average running wind speed according to the operation information of the target device when the number of operation days reaches the preset number of days.

In combination with the first possible implement of the first aspect, in a second possible implement of the first aspect, the operation information of the surrounding devices includes power-on/off time and running levels of the surrounding devices. The acquiring the first average running wind speed according to operation information of the plurality of surrounding devices includes determining average running wind speeds of the respective surrounding devices according to the power-on/off time and the running levels of the respective surrounding devices, and acquiring an average value of the average running wind speeds of the surrounding devices as the first average running wind speed.

In combination with the first implement of the first aspect, in a third implement of the first aspect, the operation information further includes running level. The acquiring a second average running wind speed according to the operation information of the target device includes calculating daily average running wind speeds of the target device according to a daily running level and power-on/off time of the target device in the preset number of days; and acquiring an average value of the daily average running wind speeds of the target device in the preset number of days as the second average running wind speed.

In combination with the first aspect, in a fourth implement of the first aspect, the environment data includes particle concentration data, and the attribute information of the target device includes total absorption capacity of the target device, an absorption percentage of the target device, and an area of an air contact surface of a filter element of the target device. The remaining service time of the target device determined according to the average running wind speed of the target device, the attribute information of the target device, and the environment data is:

$$t = \frac{MX}{VS ρ}$$

where t is the remaining service time of the target device, M is the total absorption capacity of the target device, X is the absorption percentage of the target device, V is the average running wind speed of the target device, S is the area of the air contact surface of the filter element of the target device, and ρ is particle concentration data.

In combination with the first aspect, in a fifth possible implement of the first aspect, after determining the remaining service time of the target device according to the average running wind speed of the target device, the attribute information of the target device, and the environment data, the method further includes sending prompt information to a control terminal of the target device so that the control terminal presents a prompt according to the prompt information or, sending prompt information to the target device so that the target device presents a prompt according to the prompt information.

According to a second aspect of the present disclosure, there is provided a device for determining remaining service time, including, a processor, an instruction executable by the processor. The processor is configured to perform acquiring operation information of a target device, which includes power-on/off time of the target device, determining an average running wind speed of the target device according to the operation information, and determining the remaining service time of the target device according to the average running wind speed of the target device, attribute information of the target device and environment data.

According to a second aspect of the present disclosure, there is provided a non-transitory computer readable storage medium, when instructions in the storage medium are executed by the processor of a terminal, the terminal may execute a method for determining remaining service time, comprising acquiring operation information of a target device, which comprises power-on/off time of the target device, determining an average running wind speed of the target device according to the operation information, and determining the remaining service time of the target device according to the average running wind speed of the target device, attribute information of the target device and environment data.

The technical solution provided by the present disclosure embodiments may include the following advantageous effects.

By acquiring operation information of a target device and determining an average running wind speed of the target device according to the operation information, the remaining service time of the target device is thus determined according to the average running wind speed of the target device, attribute information of the target device and environment data. Since the remaining service time of the target device is determined according to some reliable data such as operation information of the target device, attribute information of the target device and environment data, the real use state of the device may be reflected more accurately.

It is to be understood that both the foregoing general description and the following detailed description are exemplary and explanatory only and are not restrictive of the invention, as claimed.

### DRAWINGS

The accompanying drawings, which are incorporated in and constitute a part of this specification, illustrate embodiments consistent with the disclosure and, together with the description, serve to explain the principles of the present disclosure.

FIG. 1 is a flow chart of a method for determining the remaining service time according to an exemplary embodiment.

FIG. 2 is a diagram showing a structure of a filter element of a target device according to an exemplary embodiment.

FIG. 3 is a flow chart of a method for determining the remaining service time according to an exemplary embodiment.

FIG. 4 is a block diagram of an apparatus for determining the remaining service time according to an exemplary embodiment.

FIG. 5 is a block diagram of a first determination module according to an exemplary embodiment.

FIG. 6 is a block diagram of an apparatus for determining the remaining service time according to an exemplary embodiment.

FIG. 7 is a block diagram of a device for determining the remaining service time according to an exemplary embodiment.

Embodiments of the present disclosure are shown by the above drawings, and more detailed description will be made hereinafter. These drawings and text description are not for limiting the scope of conceiving the present disclosure in any way, but for illustrating the concept of the present disclosure for those skilled in the art by referring to embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise expressed. The implementations set forth in the following description of exemplary embodiments do not represent all implementations consistent with the invention. Instead, they are merely examples of apparatuses and methods consistent with aspects related to the invention as recited in the appended claims.

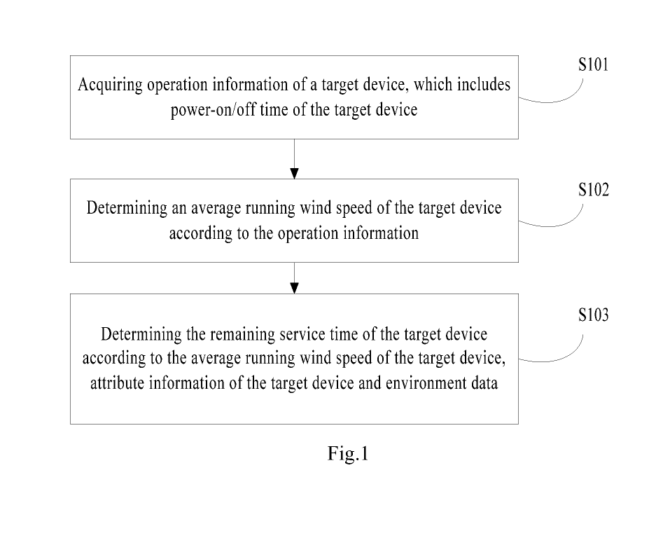

FIG. 1 is a flow chart of a method for determining remaining service time according to an exemplary embodiment. As shown in FIG. 1, the method for determining the remaining service time is applied in a server, including the following steps.

In step S101, operation information of a target device is acquired, which includes power-on/off time of the target device.

In step S102, an average running wind speed of the target device is determined according to the operation information.

In step S103, the remaining service time of the target device is determined according to the average running wind speed of the target device, attribute information of the target device and environment data.

The method of the present disclosure embodiment determines the remaining service time of the target device according to the average running wind speed of the target device, attribute information of the target device and environment data by acquiring operation information of a target device and determining an average running wind speed of the target device according to the operation information. Since the remaining service time of the target device is determined according to some reliable data such as operation information of the target device, attribute information of the target device and environment data, the real use state of the device may be reflected more accurately.

In an embodiment of the present disclosure, the determining an average running wind speed of the target device according to the operation information includes, determining the number of operation days of the target device according to the power-on/off time of the target device, determining whether the number of operation days reaches a preset number of days, acquiring a first average running wind speed according to operation information of a plurality of surrounding devices when the number of operation days does not reach the preset number of days, and acquiring a second average running wind speed according to the operation information of the target device when the number of operation days reaches the preset number of days.

In an embodiment of the present disclosure, the operation information of the surrounding devices includes power-on/off time and running levels of the surrounding devices. and the acquiring the first average running wind speed according to operation information of the plurality of surrounding devices includes, determining average running wind speeds of the respective surrounding devices according to the power-on/off time and the running levels of the respective surrounding devices, and acquiring an average value of the average running wind speeds of the surrounding devices as the first average running wind speed.

In an embodiment of the present disclosure, the operation information further includes running level, and the acquiring a second average running wind speed according to the operation information of the target device includes calculating daily average running wind speeds of the target device according to a daily running level and power-on/off time of the target device in the preset number of days, and acquiring an average value of the daily average running wind speeds of the target device in the preset number of days as the second average running wind speed.

In an embodiment of the present disclosure, the environment data includes particle concentration data, and the attribute information of the target device includes total absorption capacity of the target device, an absorption percentage of the target device, and an area of an air contact surface of a filter element of the target device. In the present disclosure, alternatively, the particle concentration data is average particle concentration data obtained through statistics on weather data of a place where the target device is located for a long term or for a period of time. Alternatively, the period of time may be last week, last month, or the latest three months, etc. The total absorption capacity of the target device is determined by the marital of the filter element of the target device, and different martial of the filter element corresponds to different total absorption capacity. In order to facilitate the determination of the total absorption capacity of the target device according to different martial of filter elements, the method provided by the present embodiment may set a corresponding relationship between the material of a filter element and the total absorption capacity before the determination of the remaining service time of the target device. As a result, when the material of a filter element of the target device is determined, the total absorption capacity of the target device may be determined by querying the corresponding relationship between the material of the filter element and the total absorption capacity. The adsorption percentage of the target device is the degree to which the particles currently in the air entering into the target device are absorbed by the target device. For example, if before entering into the target device, particles in the air per unit volume are 10,000, and after purification, particles in the air per unit volume are 4,000, the adsorption percentage of the target device is 60%.

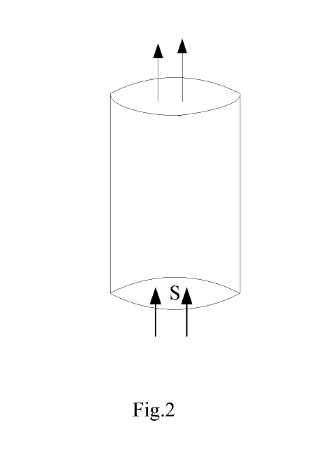

Taking FIG. 2 as an example, the area of the air contact surface of a filter element of the target device is illustrated. FIG. 2 shows a filter element of the target device. FIG. 2 shows that the filter element of the target device is cylinder, and the direction of the upward arrow indicates the direction of the air flow, and thus the area of the air contact surface of a filter element of the target device is the base area S of the cylinder.

The remaining service time of the target device determined according to the average running wind speed of the target device, the attribute information of the target device, and the environment data is:

$$t = \frac{MX}{VS ρ}$$

where t is the remaining service time of the target device, M is the total absorption capacity of the target device, X is the absorption percentage of the target device, V is the average running wind speed of the target device, which may be determined through the above method, S is the area of the air contact surface of the filter element of the target device, and ρ is the particle concentration data.

In an embodiment of the present disclosure; after determining the remaining service time of the target device according to the average running wind speed of the target device, the attribute information of the target device, and the environment data, the method further includes sending prompt information to a control terminal of the target device so that the control terminal presents a prompt according to the prompt information, or sending prompt information to the target device so that the target device presents a prompt according to the prompt information.

The above alternative technical solution may be combined into an alternative embodiment of the present invention in an arbitrary manner, which is not repeated one by one.

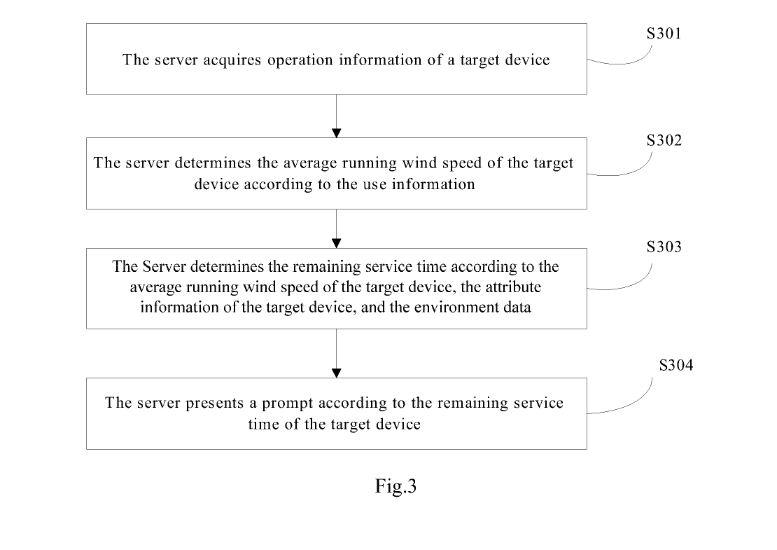

FIG. 3 is a flow chart of a method for determining the remaining service time according to an exemplary embodiment. As shown in FIG. 3, the method for determining remaining service time is applied in a server, including the following steps.

In step S301, the server acquires operation information of a target device.

The target device and the surrounding device involved in the embodiments of the present disclosure are the same kind of device and each of them may be, for example, an air purifier. The target device is a device for which the remaining service time will be calculated. The operation information of the target device at least includes power-on/off time of the target device, etc.

Since the functions of the server or the target device are different, the process of acquiring the operation information by the server may be one of the following situations.

In an embodiment of the present disclosure, the target device may have recording and pushing functions, which can automatically record the number of times the target device are powered on and off, power on and off time at every time the target device is powered on and off, running level, and the like, and push the recorded data to server. The server may have monitoring and storing functions, which can monitor air quality in a place where the target device is located, acquire the environment data indicative of the air quality, and store the pushed data by the target device and the monitored environment data into a storage unit such as memory, flash memory, or the like. Based on the functions of the target device and the server, the server may directly acquire the operation information of the target device from the corresponding storage unit.

In another embodiment of the present disclosure, the target device may also have recording, monitoring, and storing functions, which can automatically record the number of times the target device are powered on and off, power on and off time at every time the target device is powered on and off, running level, and the like, and can also monitor air quality in a duration time in which the target device is powered on and off, acquire the environment data indicative of the air quality, and store the acquired data into a storage unit such as memory, flash memory, or the like. The server may have a query function, which can query data in the target device. Based on the functions of the target device and the server, the server may query the operation information of the target device from the storage unit of the target device and acquire the queried data when acquiring operation information of the target device.

In another embodiment of the present disclosure, the target device may have recording and pushing functions, which can automatically record the number of times the target device are powered on and off, power on and off time at every time the target device is powered on and off, running level, and the like, and push the recorded data to a control terminal to be stored. The control terminal may be a terminal bound with the target device, which may be a mobile terminal, tablet computer, etc. The server may further have a query function, which can query data from the control terminal. Based on the functions of the target device and the server, the server may query the operation information of the target device from the control terminal and acquire the queried data when acquiring operation information of the target device.

The target and the server may further have other functions in addition to the above functions, and the present embodiment does not expatiate any more. Correspondingly, the server may employ other manners in addition to the above-mentioned manners when acquiring operation information of the target device. The present embodiment does not describe these manners one by one.

In step S302, the server determines the average running wind speed of the target device according to the operation information.

Herein, the running wind speed of the target device is a wind speed generated when the target device is running. The average running wind speed may reflect the loss condition of the target device which decides the remaining use lifespan of the target device. Thus, in order to determine the remaining use lifespan of the target device, the method provided by the present embodiment needs to firstly determine the average running wind speed of the target device. In addition, the operation information of the target device can accurately represent the current use condition of the target device. Therefore, in order to improve the accuracy for determining the remaining service time of the target device, in the present embodiment, the server determines the average running wind speed of the target device according to the operation information of the target device.

The server may employ the following manners (1)˜(3) when determining the average running wind speed of the target device according to the operation information.

(1) The server determines the number of operation days of the target device according to the power-on/off time of the target device.

Herein, the power-on/off time may be power-on timing and power-off timing, and may be also the duration time between the power-on timing and the power-off timing. In all of the embodiments of the present disclosure, the power-on/off time is set as the power-on timing and the power-off timing. In addition, since the power-on/off time of the target device is recorded by the target device for many times, in order to manage the recorded power-on/off time, the target device may record the date corresponding to the power-on/off time together with the recorded power-on/off time. Thus, based on the date corresponding to the recorded power-on/off time, the server may determine the number of operation days of the target device.

Taking data recorded in table I as an example, the process for determining the number of operation days of the target device according to the power-on/off time by the server is described in detail.

TABLE I

| Power on and off times | Power-on/off time |
|---|---|
| 1 | Jan. 1, 2014 6:00~9:00 |
| 2 | Jan. 4, 2014 12:30~15:30 |
| 3 | Jan. 9, 2014 20:00~21:00 |
| 4 | Jan. 16, 2014 9:00~11:00 |
| 5 | Jan. 17, 2014 10:30~14:00 |
| 6 | Jan. 17, 2014 16:00~19:00 |
| 7 | Jan. 23, 2014 8:00~11:00 |
| 8 | Jan. 23, 2014 7:00~9:30 |
| 9 | Jan. 25, 2014 16:00~21:00 |
| 10 | Jan. 31, 2014 7:00~10:00 |

Based on the power-on/off time recorded in table I, the server may determine the number of operation days of the target device, that is, 8 days.

(2) The server determines whether the number of operation days reaches a preset number of days.

In this embodiment, as the service time of the target device is different, the server may employ different calculation method to calculate the average running wind speed of the target device. For this reason, in the method provided by this embodiment, before the average running wind speed of the target device is determined according to the operation information of the target device, whether the number of operation days reaches a preset number of days is further determined. Herein, the preset number of days may be 20 days, 30 days, 50 days, etc. This embodiment does not make a specific limitation to the preset number of days. Specifically, the server may determine whether the number of operation days reaches a preset number of days by directly comparing the number of operation days with the preset number of days.

(3) The server determines the average running wind speed of the target device according to the comparison result.

When comparing the number of operation days with the preset number of days, the comparison result may be the following two results: the number of operation days does not reach the preset number of days, and the number of operation days reaches the preset number of days. As for the two comparison results, the server may determine the average running wind speed of the target device in the following manners (3.1)˜(3.2).

(3.1) When the number of operation days does not reach the preset number of days, the server may acquire a first average running wind speed according to operation information of a plurality of surrounding devices.

When the number of operation days of the target device does not reach a preset number of days, it illustrates that the number of operation days of the target device is not long enough. Thus, the average running wind speed determined according to the operation information of the target device is not possibly accurate. In such a case, the server may acquire the first average running wind speed according to the operation information of the plurality of surrounding devices, as the average running wind speed of the target device.

Herein, the surrounding devices may be devices within a designated range of the target device. The designated range of the target device may be a circumference range of a circle with the target device as the center and the radius of a preset length. The preset length may be 1 Km (kilometer), 2 Km, 3 Km, etc. This embodiment does not make a specific limitation to the preset length. The operation information of a surrounding device at least includes power-on/off time and running level of the surrounding device.

Since the devices in this embodiment may access the Internet, when each device acquires location information on where the device is located through the Internet, the device may send the acquired location information to a server. Thus, if a target device is determined, the server may determine the plurality of surrounding devices within the designated range of the target device according to the received location information. The server may also determine a plurality of surrounding devices within the designated range of the target device according to an IP address of each device. In addition to the above manners, the server may inquire about delivery addresses corresponding to the target device and other devices from the stored consumption recordation in user's account, and thus determine a plurality of surrounding devices within the designated range of the target device according to the delivery addresses.

It should be noted that in this embodiment, the running level of a device may be an ordinary level, a strong level, a sleeping level, etc. When the device is running in different levels, the running wind speeds of the device are different. Herein, when the device is running in the sleeping level, the running wind speed is minimum and may be set as a first speed. When the device is running in the ordinary level, the running wind speed is smaller than the running wind speed of the sleeping level and may be set as a second speed. When the device is running in the strong level, the running wind speed is maximum and may be set as a third speed. The first speed is smaller than the second speed, and the second speed is smaller than the third speed.

When determining that the number of operation days does not reaches the preset number of days, the server may acquire a first average running wind speed according to the operation information of a plurality of the surrounding devices in the following manners (3.11)˜(3.12).

(3.11) The server determines an average running wind speed of each surrounding device according to power-on/off time and running level of each surrounding device.

Since the storage unit in the server may store operation information of all the devices including the target device and the surrounding devices, the server may directly acquire power-on/off time and running level of each of the surrounding devices from the corresponding storage unit thereof.

Based on the acquired power-on/off time and running levels of the plurality of the surrounding devices, as for each surrounding device, the server may determine the length of the power-on/off time of each surrounding device according to daily power-on/off time of each surrounding device in a preset number of days, thereafter determine daily running wind speeds of each surrounding device according to the length of the power-on/off time and corresponding running level of each surrounding device, and thus acquire an average value of running wind speeds of each surrounding device in the preset number of days, as the average running wind speed of each surrounding device.

For example, table II shows operation information of a surrounding device A and the length of power-on/off time calculated according to the operation information. The running wind speed corresponding to the sleeping level is v₁(/h), the running wind speed corresponding to the ordinary level is v₂(/h), and the running wind speed corresponding to the strong level is v₃(/h).

TABLE II

| Power on | | Length of | |
|---|---|---|---|
| and off | | power-on/off | |
| times | Power-on/off time | time (hour) | Running level |
| 1 | Jan. 1, 2014 6:00~9:00 | 3 | Ordinary level |
| 2 | Jan. 4, 2014 12:30~15:30 | 3 | Strong level |
| 3 | Jan. 9, 2014 20:00~21:00 | 1 | Sleeping level |
| 4 | Jan. 16, 2014 9:00~11:00 | 2 | Strong level |
| 5 | Jan. 17, 2014 10:30~14:00 | 3.5 | Ordinary level |
| 6 | Jan. 17, 2014 16:00~19:00 | 3 | Sleeping level |
| 7 | Jan. 23, 2014 8:00~11:00 | 3 | Strong level |
| 8 | Jan. 23, 2014 7:00~9:30 | 2.5 | Strong level |
| 9 | Jan. 25, 2014 16:00~21:00 | 5 | ordinary level |
| 10 | Jan. 31, 2014 7:00~10:00 | 3 | Strong level |

Based on the data shown in table II, the server may calculate the average running wind speed of the surrounding device A, that is, (3*v₂+3*v₃+1*v₁+2*v₃+3.5*v₂+3*v₁+3*v₃+2.5*v₃+5*v₂+3*v₃)/29=(4 v₁+11.5 v₂+10.5 v₃)/29.

(3.12) The server acquires an average value of average running wind speeds of the plurality of surrounding devices in a preset number of days, as a first average running wind speed.

After acquiring the average value of average running wind speeds of the plurality of surrounding devices, the server may acquire an average value of average running wind speeds of the plurality of surrounding devices in a preset number of days based on the acquired average value of average running wind speeds of the plurality of surrounding devices, as the first average running wind speed.

For example, five surrounding devices acquired by the server are respectively: a surrounding device A, a surrounding device B, a surrounding device C, a surrounding device D, and a surrounding device E. The average running wind speed of the surrounding device A is a₁ v₁+b₁ v₂+c₁ v₃, the average running wind speed of the surrounding device B is a₂ v₁+b₂ v₂+c₂ v₃, the average running wind speed of the surrounding device C is a₃ v₁+b₃ v₂+c₃ v₃, the average running wind speed of the surrounding device D is a₄ v₁+b₄ v₂+c₄ v₃, and the average running wind speed of the surrounding device E is a₅ v₁+b₅ v₂+c₅v₃ The average value of average running wind speeds of the five surrounding devices is equal to [(a₁ v₂+c₁ v₃)+(a_{z} v₁+b₂ v₂+c₂ v₃)+(a₃ v₁+b₃ v₂+c₃ v₃)+(a₄ v₂+c₄ v₃)+(a₅ v₁+b₅ v₂+c₅v₃)]/5=[(a₁+a₂+a₃+a₄+a₅) v₁+(b₁+b₂+b₃+b₄+b₅) v₂+(c₁+c₂+c₃+c₄+c₅) v₃]/5.

(3.2) When the number of operation days reaches a preset number of days, the server acquires a second average running wind speed according to the operation information of the target device.

When the number of operation days of the target device reaches a preset number of days, it illustrates that the number of operation days of the target device is long enough. Thus, the average running wind speed is more accurately determined according to the operation information of the target device. In such a case, the server may acquire the second average running wind speed according to the operation information of the target device, as the average running wind speed of the target device.

In the present embodiment, the operation information of the target device further includes running levels. Based on the operation information of the target device, the server may employ the following manners (3.21)˜(3.22) when acquiring the second average running wind speed.

(3.21) The server calculates daily average running wind speeds of the target device according to a daily running level and power-on/off time of the target device in a preset number of days.

Based on the acquired operation information of the target device, the server may determine a length of power-on/off time of the target device according to a daily power-on/off time of the target device in the preset number of days, and thereafter, calculate daily average running wind speeds of the target device according to a daily running level and the length of power-on/off time of each target device.

For example, table III shows operation information of the target device on Jun. 4, 2014 and the length of power-on/off time calculated according to the operation information. The running wind speed corresponding to the sleeping level is v₁(/h), the running wind speed corresponding to the ordinary level is v₂(/h), and the running wind speed corresponding to the strong level is v₃(/h).

TABLE III

| Power on | | Length of | |
|---|---|---|---|
| and off | | Power-on/off | |
| times | Power-on/off time | time (Hour) | Running level |
| 1 | Jun. 4, 2014 6:00~9:00 | 3 | ordinary level |
| 2 | Jun. 4, 2014 12:30~15:30 | 3 | strong level |
| 3 | Jun. 4, 2014 20:00~21:00 | 1 | sleeping level |

Based on the data shown in table III, the server may calculate the average running wind speed of the target device on Jun. 4, 2014, that is, (3*v₂+3*v₃+1*v₁)/7.

(3.22) The server acquires an average value of daily average running wind speeds of the target device in a preset number of days as a second average running wind speed.

After calculating daily average running wind speeds of the target device in the preset number of days, the server may acquire an average value of the daily average running wind speeds of the target device in the preset number of days based on the calculated daily average running wind speeds of the plurality of target device in the preset number of days, as the second average running wind speed.

For example, assuming the preset number of days is set as 30 days, and the daily average running wind speed of the target device in the preset number of days is: a₁ v₁+b₁ v₂+c₁ v₃, a₂ v₁+b₂ v₂+c₂v₃, a₃ v₁+b₃ v₂+c₃, . . . , a₃₀ v₁+b₃₀v₂+c₃₀v₃, the average value of the daily average running wind speeds of the target device in the preset number of days is equal to [(a₁ v₁+b₁ v₂+c₁ v₃)+(a₂ v₁+b₂ v₂+c₂ v₃)+(a₃ v₁+b₃ v₂+c₃ v₃)+ . . . +(a₃₀ v₁+b₃₀ v₂+c₃₀v₃)]/30, that is, the second average running wind speed is equal to [a₁ v₁+b₁ v₂+c₁ v₃)+(a₂ v₁+b₂ v₂+c₂ v₃)+(a₃ V₁+b₃ v₂+c₃ v₃)+ . . . +(a₃₀ v₁+b₃₀ v₂+c₃₀v₃)]/30.

In step S303, the server determines the remaining service time according to the average running wind speed of the target device, the attribute information of the target device, and the environment data.

In the present example, the remaining service time of the target device is not only related to the average running wind speed of the target device but also related to the attribute information of the target device, and the environment data. Thus, in the present example, in order to improve the accuracy for determining the remaining service time of the target device, the server needs to comprehensively consider the average running wind speed of the target device, the attribute information of the target device, and the environment data to determine the remaining service time of the target device. Herein, the environment data is an average value obtained by a long-term monitoring to the air quality in a place in which the target device is located, and at least includes particle concentration data and the like. The attribute information at least includes total absorption capacity of the target device, an absorption percentage of the target device, an area of an air contact surface of a filter element of the target device, and the like. The concrete meaning of each parameter in the attribute information may refer to the meaning of the above respective parameters, and more details will be repeated no more.

When determining the remaining service time of the target device according to the average running wind speed of the target device, the attribute information of the target device, and the environment data, the following equation (1) is usually employed:

$$t = \frac{MX}{VS ρ} \qquad ( 1 )$$

where t is the remaining service time of the target device, M is the total absorption capacity of the target device, X is the absorption percentage of the target device, V is the average running wind speed of the target device, S is the area of the air contact surface of the filter element of the target device, and ρ is the particle concentration data.

It should be noted that since the environment data where the target device is located is different in different seasons, in order to improve the accuracy for determining the remaining use lifespan, the method provided by this embodiment may make a statistics on the acquired environment data at a preset time interval so as to obtain an average value of the environment data. Thereafter, the remaining service time of the target device may be determined according to the average value of the environment data.

In step S304, the server may present a prompt according to the remaining service time of the target device.

In order to remind of the current state of the target device in time and avoid the problem that the target device does not work normally due to lack of timely replacement, the method provided by the embodiment may present a prompt according to the remaining service time of the target device after determining the remaining service time of the target device. Specifically, the server may send prompt information to a control terminal of the target device so that that control terminal presents a prompt according to the prompt information. Herein, the prompt information may carry the remaining service time of the target device. After receiving the prompt information, the control terminal may present a prompt by displaying the remaining service time in a display interface, and may perform a reminder in the display interface in a flashing prompt manner. Of course, the server may send prompt information to the target device so that the target device presents a prompt according to the prompt information. This embodiment does not make a specific limitation to the prompt manner.

The method provided by the embodiment of the present disclosure determines the remaining service time of the target device according to the average running wind speed of the target device, attribute information of the target device and environment data by acquiring operation information of a target device and determining an average running wind speed of the target device according to the operation information. Since the remaining service time of the target device is determined according to some reliable data such as operation information of the target device, attribute information of the target device and environment data, the real use state of the device may be reflected more accurately, which is more precise in comparison with the user's experience. In addition, after determining the remaining service time of the target device, the server may present a prompt by sending prompt information, thus reminding users in time, whereby the target device is ensured to work normally.

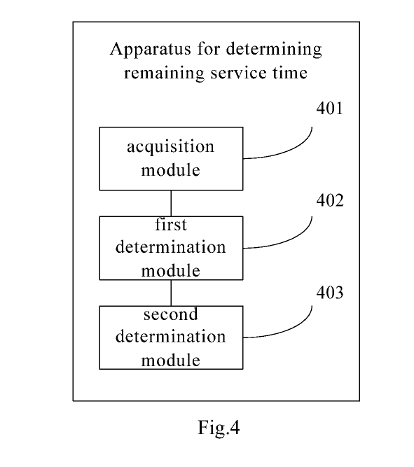

FIG. 4 is a block diagram showing an apparatus for determining remaining service time according to an exemplary embodiment. Referring to FIG. 4, the apparatus includes an acquisition module 401, a first determination module 402, and a second determination module 403.

The acquisition module 401 is configured to acquire operation information of a target device, which includes power-on/off time of the target device.

The first determination module 402 is configured to determine an average running wind speed of the target device according to the operation information.

The second determination module 403 is configured to determine the remaining service time of the target device according to the average running wind speed of the target device, attribute information of the target device and environment data.

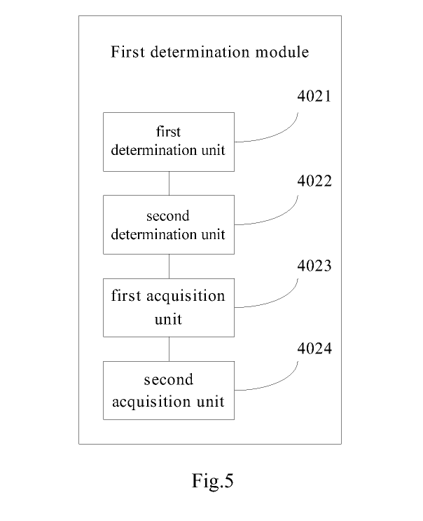

Referring to FIG. 5, the first determination module includes a first determination unit 4021, a second determination unit 4022, a first acquisition unit 4023, and a second acquisition unit 4024.

The first determination unit 4021 is configured to determine the number of operation days of the target device according to power-on/off time of the target device.

The second determination unit 4022 is configured to determine whether the number of operation days reaches a preset number of days.

The first acquisition unit 4023 is configured to acquire a first average running wind speed according to operation information of a plurality of surrounding devices when the number of operation days does not reach the preset number of days.

The second acquisition unit 4024 is configured to acquire a second average running wind speed according to the operation information of the target device when the number of operation days reaches the preset number of days.

In an embodiment of the present disclosure, the operation information of the surrounding devices includes power-on/off time and running levels of the surrounding devices, and the first acquisition unit 4023 is further configured to determine average running wind speeds of the respective surrounding devices according to the power-on/off time and the running levels of the respective surrounding devices, and acquire an average value of the average running wind speeds of the surrounding devices as the first average running wind speed.

In an embodiment of the present disclosure, the operation information further includes running level, and the second acquisition unit 4024 is configured to calculate daily average running wind speeds of the target device according to daily running levels and power-on/off time of the target device in the preset number of days, and acquire an average value of the daily average running wind speeds of the target device in the preset number of days, as the second average running wind speed.

In an embodiment of the present disclosure, the environment data includes particle concentration data, and the attribute information of the target device includes total absorption capacity of the target device, an absorption percentage of the target device, and an area of an air contact surface of a filter element of the target device.

The remaining service time of the target device determined by the second determination unit is:

$$t = \frac{MX}{VS ρ}$$

where t is the remaining service time of the target device, M is the total absorption capacity of the target device, X is the absorption percentage of the target device, V is the average running wind speed of the target device, S is the area of the air contact surface of the filter element of the target device, and ρ is the particle concentration data.

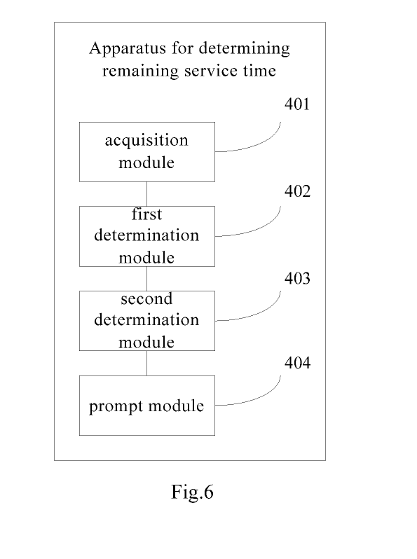

Referring to FIG. 6, the apparatus further includes a prompt module 404.

The prompt module 404 is configured to send prompt information to a control terminal of the target device so that the control terminal presents a prompt according to the prompt information.

Alternatively, the prompt module 404 is configured to send prompt information to the target device so that the target device presents a prompt according to the prompt information.

The apparatus provided by the embodiment of the present disclosure determines the remaining service time of the target device according to the average running wind speed of the target device, attribute information of the target device and environment data by acquiring operation information of a target device and determining an average running wind speed of the target device according to the operation information. Since the remaining service time of the target device is determined according to some reliable data such as operation information of the target device, attribute information of the target device and environment data, the real use state of the device may be reflected more accurately.

With regard to the apparatus in the above embodiment, detailed description of specific manner of respective modules for performing operation has been made in the embodiment related to the method, and no detailed illustration will be made herein.

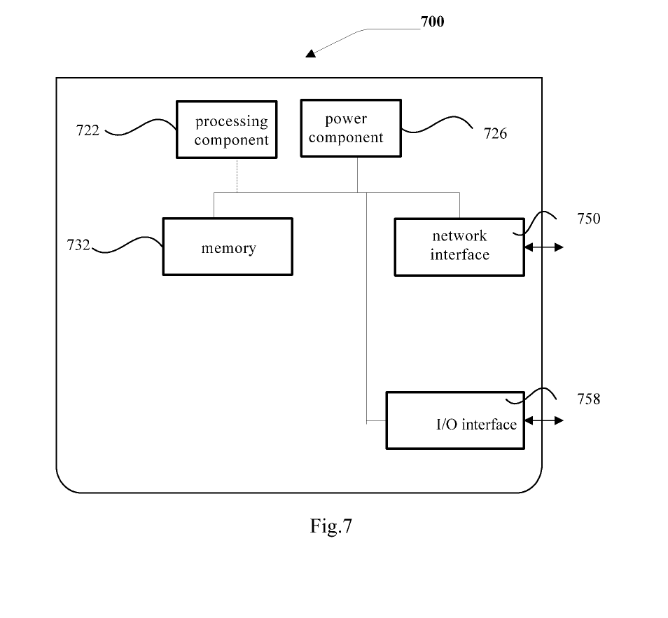

FIG. 7 is a structure diagram showing a device 700 for determining remaining service time according to an exemplary embodiment. For example, the device 700 may be provided as a server. As shown in FIG. 7, the device 700 includes a processing component 722 that further includes one or more processors, and memory resources represented by a memory 732 for storing instructions, such as application programs, executable by the processing component 722. The application programs stored in memory 732 may include one or more modules, each of which corresponds to a set of instructions. Moreover, the processing component 722 is configured to execute instructions for performing the following method for determining remaining service time: acquiring operation information of a target device, which includes power-on/off time of the target device, determining an average running wind speed of the target device according to the operation information, and determining the remaining service time of the target device according to the average running wind speed of the target device, attribute information of the target device and environment data.

In an embodiment of the present disclosure, the determining an average running wind speed of the target device according to the operation information includes determining the number of operation days of the target device according to the power-on/off time of the target device, determining whether the number of operation days reaches a preset number of days, acquiring a first average running wind speed according to operation information of a plurality of surrounding devices when the number of operation days does not reach the preset number of days, and acquiring a second average running wind speed according to the operation information of the target device when the number of operation days reaches the preset number of days.

In an embodiment of the present disclosure, the operation information of the surrounding devices includes power-on/off time and running levels of the surrounding devices, and the acquiring the first average running wind speed according to operation information of the plurality of surrounding devices includes determining average running wind speeds of the respective surrounding devices according to the power-on/off time and the running levels of the respective surrounding devices, and acquiring an average value of the average running wind speeds of the surrounding devices as the first average running wind speed.

In an embodiment of the present disclosure, the operation information further includes running level, and the acquiring a second average running wind speed according to the operation information of the target device includes calculating daily average running wind speeds of the target device according to a daily running level and power-on/off time of the target device in the preset number of days, and acquiring an average value of the daily average running wind speeds of the target device in the preset number of days as the second average running wind speed.

In an embodiment of the present disclosure, the environment data includes particle concentration data, and the attribute information of the target device includes total absorption capacity of the target device, an absorption percentage of the target device, and an area of an air contact surface of a filter element of the target device.

The remaining service time of the target device determined according to the average running wind speed of the target device, the attribute information of the target device, and the environment data is:

$$t = \frac{MX}{VS ρ}$$

where t is the remaining service time of the target device, M is the total absorption capacity of the target device, X is the absorption percentage of the target device, V is the average running wind speed of the target device, S is the area of the air contact surface of the filter element of the target device, and ρ is the particle concentration data.

In an embodiment of the present disclosure, after determining the remaining service time of the target device according to the average running wind speed of the target device, the attribute information of the target device, and the environment data, the method further includes sending prompt information to a control terminal of the target device so that the control terminal presents a prompt according to the prompt information, or sending prompt information to the target device so that the target device presents a prompt according to the prompt information.

The device 700 may also include a power component 726 configured to perform power management of the device 700, wired or wireless network interface(s) 750 configured to connect the device 700 to a network, and an input/output (I/O) interface 758. The device 700 may operate based on an operating system stored in the memory 732, such as Windows Server™, Mac OS X™, Unix™ Linux™, FreeBSD™, or the like.

The device provided by the embodiment of the present disclosure determines the remaining service time of the target device according to the average running wind speed of the target device, attribute information of the target device and environment data by acquiring operation information of a target device and determining an average running wind speed of the target device according to the operation information. Since the remaining service time of the target device is determined according to some reliable data such as operation information of the target device, attribute information of the target device and environment data, the real use state of the device may be reflected more accurately.

After considering this description and carrying out the embodiments disclosed herein, those skilled in the art may easily anticipate other implementation aspects of the present disclosure. The present disclosure is meant to cover any variations, use or adaptive change of these embodiments, and these variations, use or adaptive change follow general concept of the present disclosure and include the common knowledge or the customary technical means in the technical field that is not disclosed in the present disclosure. The description and embodiments are only exemplary, and the real range and spirit of the present disclosure are defined by the following claims.

It should be understood that the present disclosure is not limited to precise structures that are described above and shown in the accompanying drawings, and may be modified and changed without departing from the range of the present disclosure. The scope of the present disclosure is only defined by the appended claims.

What is claimed is:

1. A method for determining remaining service time for a filter in an air moving target device, comprising:
acquiring operation information of the air moving target device, comprising power-on/off time of the air moving target device;
determining an average running wind speed of the air moving target device based on the operation information;
sensing attribute information of the air moving target device;
sensing environment data relating to the air moving target device; and
determining the remaining service time for the filter based on the average running wind speed of the air moving target device, the attribute information of the air moving target device and the environment data.

2. The method according to claim 1, wherein the determining an average running wind speed of the air moving target device based on the operation information comprises:
determining a number of operation days of the air moving target device based on the power-on/off time of the air moving target device;
determining whether the number of operation days reaches a preset number of days;
obtaining a first average running wind speed based on operation information of a plurality of surrounding devices when the number of operation days does not reach the preset number of days; and
obtaining a second average running wind speed based on the operation information of the air moving target device when the number of operation days reaches the preset number of days.

3. The method according to claim 2, wherein the operation information of the surrounding devices comprises power-on/off time and running levels of the surrounding devices, and
the obtaining the first average running wind speed based on operation information of the plurality of surrounding devices comprises:
determining average running wind speeds of the respective surrounding devices based on the power-on/off time and the running levels of the respective surrounding devices; and
obtaining an average value of the average running wind speeds of the surrounding devices as the first average running wind speed.

4. The method according to claim 2, wherein the operation information further comprises running level, and
the obtaining a second average running wind speed based on the operation information of the air moving target device comprises:
calculating daily average running wind speeds of the air moving target device based on a daily running level and power-on/off time of the air moving target device during the preset number of days; and
acquiring an average value of the daily average running wind speeds of the air moving target device in the preset number of days as the second average running wind speed.

5. The method according to claim 1, wherein the environment data comprises particle concentration data, and the attribute information of the air moving target device comprises total absorption capacity of the air moving target device, an absorption percentage of the air moving target device, and an area of an air contact surface of the filter of the air moving target device, and
the remaining service time of the air moving target device determined based on the average running wind speed of the air moving target device, the attribute information of the air moving target device, and the environment data is:
$$t = \frac{MX}{VS ρ}$$
where t is the remaining service time of the air moving target device, M is the total absorption capacity of the air moving target device, X is the absorption percentage of the air moving target device, V is the average running wind speed of the air moving target device, S is the area of the air contact surface of the filter of the air moving target device, and ρ is the particle concentration data.

6. The method according to claim 1, further comprises:
sending prompt information to a control terminal of the air moving target device so that the control terminal presents a prompt based on the prompt information; or,
sending prompt information to the air moving target device so that the air moving target device presents a prompt based on the prompt information.

7. The method according to claim 1, wherein the air moving target device includes a rotary fan.

8. A device for determining remaining service time for a filter in an air moving target device, comprising:
a processor; and
a memory storing instructions executable by the processor,
wherein the processor is configured to perform:
obtaining operation information of the air moving target device, comprising power-on/off time of the air moving target device;
determining an average running wind speed of the air moving target device based on the operation information;
sensing attribute information of the air moving target device;
sensing environment data relating to the air moving target device; and
determining the remaining service time for the filter based on the average running wind speed of the air moving target device, the attribute information of the air moving target device and the environment data.

9. The device according to claim 8, wherein the determining an average running wind speed of the air moving target device based on the operation information comprises:
determining a number of operation days of the air moving target device based on the power-on/off time of the air moving target device;
determining whether the number of operation days reaches a preset number of days;
determining a first average running wind speed based on operation information of a plurality of surrounding devices when the number of operation days does not reach the preset number of days; and
acquiring a second average running wind speed based on the operation information of the air moving target device when the number of operation days reaches the preset number of days.

10. The device according to claim 9, wherein the operation information of the surrounding devices comprises power-on/off time and running levels of the surrounding devices, and
the acquiring the first average running wind speed based on operation information of the plurality of surrounding devices comprises:
determining average running wind speeds of the respective surrounding devices based on the power-on/off time and the running levels of the respective surrounding devices; and
acquiring an average value of the average running wind speeds of the surrounding devices as the first average running wind speed.

11. The device according to claim 9, wherein the operation information further comprises running level, and
the acquiring a second average running wind speed based on the operation information of the air moving target device comprises:
calculating daily average running wind speeds of the air moving target device based on a daily running level and power-on/off time of the air moving target device during the preset number of days; and
acquiring an average value of the daily average running wind speeds of the air moving target device in the preset number of days as the second average running wind speed.

12. The device according to claim 8, wherein the environment data comprises particle concentration data, and the attribute information of the air moving target device comprises total absorption capacity of the air moving target device, an absorption percentage of the air moving target device, and an area of an air contact surface of the filter of the air moving target device, and
the remaining service time of the air moving target device determined based on the average running wind speed of the air moving target device, the attribute information of the air moving target device, and the environment data is:
$$t = \frac{MX}{VS ρ}$$
where t is the remaining service time of the air moving target device, M is the total absorption capacity of the air moving target device, X is the absorption percentage of the air moving target device, V is the average running wind speed of the air moving target device, S is the area of the air contact surface of the filter of the air moving target device, and ρ is the particle concentration data.

13. The device according to claim 8, further comprises:
sending prompt information to a control terminal of the air moving target device so that the control terminal presents a prompt based on the prompt information; or,
sending prompt information to the air moving target device so that the air moving target device presents a prompt based on the prompt information.

14. The device according to claim 8, wherein the air moving target device includes a rotary fan.

15. A non-transitory computer readable storage medium having stored therein instructions that, when executed by a processor of a terminal, causes the terminal to execute a method for determining remaining service time for a filter in an air moving target device, the method comprising:
acquiring operation information of the air moving target device, the operation information comprising power-on/off time of the air moving target device;
determining an average running wind speed of the air moving target device based on the operation information;
sensing attribute information of the air moving target device;
sensing environment data relating to the air moving target device; and
determining the remaining service time for the filter based on the average running wind speed of the air moving target device, the attribute information of the air moving target device and the environment data.

16. The medium according to claim 15, wherein the determining an average running wind speed of the air moving target device based on the operation information comprises:
determining a number of operation days of the air moving target device based on the power-on/off time of the air moving target device;
determining whether the number of operation days reaches a preset number of days;
obtaining a first average running wind speed based on operation information of a plurality of surrounding devices when the number of operation days does not reach the preset number of days; and
obtaining a second average running wind speed based on the operation information of the air moving target device when the number of operation days reaches the preset number of days.

17. The medium according to claim 16, wherein the operation information of the surrounding devices comprises power-on/off time and running levels of the surrounding devices, and
the obtaining the first average running wind speed based on operation information of the plurality of surrounding devices comprises:
determining average running wind speeds of the respective surrounding devices based on the power-on/off time and the running levels of the respective surrounding devices; and
obtaining an average value of the average running wind speeds of the surrounding devices as the first average running wind speed.

18. The medium according to claim 16, wherein the operation information further comprises running level, and
the obtaining a second average running wind speed based on the operation information of the air moving target device comprises:
calculating daily average running wind speeds of the air moving target device based on a daily running level and power-on/off time of the air moving target device during the preset number of days; and
acquiring an average value of the daily average running wind speeds of the air moving target device in the preset number of days as the second average running wind speed.

19. The medium according to claim 15, wherein the environment data comprises particle concentration data, and the attribute information of the air moving target device comprises total absorption capacity of the air moving target device, an absorption percentage of the air moving target device, and an area of an air contact surface of the filter of the air moving target device, and
the remaining service time of the air moving target device determined based on the average running wind speed of the air moving target device, the attribute information of the air moving target device, and the environment data is:
$$t = \frac{MX}{VS ρ}$$
where t is the remaining service time of the air moving target device, M is the total absorption capacity of the air moving target device, X is the absorption percentage of the air moving target device, V is the average running wind speed of the air moving target device, S is the area of the air contact surface of the filter of the air moving target device, and ρ is the particle concentration data.

20. The medium according to claim 15, further comprises:
sending prompt information to a control terminal of the air moving target device so that the control terminal presents a prompt based on the prompt information; or,
sending prompt information to the air moving target device so that the air moving target device presents a prompt based on the prompt information.
